(19) United States
(12) Patent Application Publication
(10) Pub. No.: US 2022/0342333 A1
(43) Pub. Date: Oct. 27, 2022

(54) TONER BLENDS COMPRISING OF A CLEAR TONER AND A PIGMENTED TONER

(71) Applicant: LEXMARK INTERNATIONAL, INC., LEXINGTON, KY (US)

(72) Inventors: KASTURI RANGAN SRINIVASAN, LONGMONT, CO (US); SCOTT DANIEL REEVES, LOUISVILLE, CO (US)

(21) Appl. No.: 17/236,525

(22) Filed: Apr. 21, 2021

(51) Int. Cl. G03G 9/093; G03G 9/097; G03G 9/08

(52) U.S. Cl. CPC G03G 9/09371; G03G 9/09708; G03G 9/09725; G03G 9/0819; G03G 9/09328

(57) ABSTRACT

Provided is a toner blend composition comprising a first pigmented toner and a second toner that is devoid of any pigment additive, i.e., a ‘non-pigmented or clear toner’. The non-pigmented or clear toner is about 1% to about 15% by weight of the toner blend composition. The resulting inventive toner blend composition surprisingly exhibits similar print density on a page compared to a fully pigmented toner. Moreover, this toner blend composition exhibits improvement in toner usage per page, thus lowering toner cost compared to a fully pigmented toner. The non-pigmented or clear toner may be used in combination with either a monochrome or conventional toner using a carbon black pigment, or a chemically processed toners (‘CPT”) toners using a black pigment, magenta pigment, yellow pigment or a cyan pigment.

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Field of the Invention

The present invention relates generally to a toner blend comprising of at least one pigmented toner and a second toner that is devoid of any pigment additive, i.e., a ‘non-pigmented or clear toner’. The non-pigmented or clear toner is comprised of a toner resin and a release agent, and optionally a charge control agent. The non-pigmented or clear toner is about 1% to about 15% by weight of the inventive blended pigmented toner. The resulting toner blend comprising of the pigmented toner and non-pigmented or clear toner surprisingly exhibits similar print density on a page compared to a fully pigmented toner when used at less than about 8% by weight of the non-pigmented or clear toner. Moreover, this toner blend exhibits improvement in toner usage per page, thus lowering toner cost. The non-pigmented or clear toner may be used in combination with either a monochrome or conventional toner using a carbon black pigment, or a chemically processed toners (‘CPT”) toners using a black pigment, magenta pigment, yellow pigment or a cyan pigment. Also, the surface wax domains of the non-pigmented or clear toner are no greater than 200 nm, when measured via a surface etching technique involving oxygen plasma.

### 2. Description of the Related Art

Toner may be utilized in image forming devices, such as printers, copiers and/or fax machines to form images upon a sheet of media. The image forming apparatus may transfer the toner from a reservoir to the media via a developer system utilizing differential charges generated between the toner particles and the various components in the developer system. The print darkness of the image is dependent on the pigment dispersibility in the toner matrix, the color gamut, and toner charge. By using a blend of a pigmented toner and a second toner that is devoid of any pigment additive, the desirable print density may still be achieved, while improving the toner usage, thereby lowering overall toner cost.

### SUMMARY OF THE INVENTION

An aspect of the present disclosure relates to a toner composition which may be used in an electrophotographic printer or printer cartridge. The color and color density of the image achieved by printing toners can be suitably adjusted by the pigment type and pigment concentration (by weight). One approach to lower the cost of the toner is to lower the pigment loading in a toner, however, this often negatively impacts the color density of the image achieved by the toner. An alternate approach to lower the cost of manufacturing the toner would be to use some toner particles that do not contain any pigment (organic or inorganic). The present inventive blended toner composition successfully dilutes a conventional carbon black or a CPT pigmented toner by using a non-pigmented or clear toner, wherein the non-pigmented toner is about 1% by weight to about 15% by weight of the resulting blended toner composition, preferably less than 8% of the resulting blended toner composition. This inventive CPT or conventional blended toner composition is less expensive to manufacture and importantly exhibits a very small change in print density but an improvement in toner usage.

### BRIEF DESCRIPTION OF THE DRAWINGS

The above -mentioned and other features and advantages of the various embodiments, and the manner of attaining them, will become more apparent and will be better understood by reference to the accompanying drawings.

FIG. 1 is a scanning electron microscope image of a chemically processed cyan pigmented toner, surface etched using Oxygen plasma.

FIG. 2 is a scanning electron microscope image of a chemically processed non-pigmented clear toner, surface etched using Oxygen plasma.

FIG. 3 is a scanning electron microscope image of a melt extruded conventional black toner, surface etched using Oxygen plasma.

FIG. 4 is scanning electron microscope image of a melt extruded conventional non-pigmented clear toner, surface etched using Oxygen plasma.

### DETAILED DESCRIPTION

It is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items

### Background

Electrophotographic printers and cartridges typically use either a mechanically milled toner or a chemically prepared toner (‘CPT’). Chemically prepared toner can be a toner derived from using a suspension polymerization method, an emulsion agglomeration (‘EA’) method, or an aggregation method. Independent of the method of preparation, toner flow properties and print quality metrics can be suitably manipulated by use of extra particulate additives (‘EPA’s) to the toner particle surface. EPAs help improve the toner flow behavior, lower or eliminate the tendency to brick or cake under high temperature and/or humidity, improve transfer of toner from a photoreceptor to paper or an image transfer member, transfer between an image transfer member and paper, or regulate the toner charge across various environments (i.e., varying temperature and humidity) and improve print quality.

For color toner applications, the use of an optimum pigment is critical to achieving the required color gamut, print density and performance through life. Whereas black, cyan and yellow toners tend to be based on a single pigment, magenta toner tends to require multiple pigments. There are several magenta pigments used to achieve the required color gamut. These pigments can be based on quinacridones, naphthol, benzimidazolones, azo, etc. For example, PR122 is a quinacridone pigment, PR184 is a naphthol based azo pigment, and PR185 is a benzimidazolone based pigment. In most cases, there is a tendency to use one or more pigments to achieve the required color density/gamut, melt rheology and light fastness. However, using multiple pigments to achieve the desired results are a significant driver for toner cost. Lowering the pigment level can help lower the cost but may impact performance. Also, lowering in pigment concentration may impact performance across various printers based on the printer settings and hence result in the need for multiple toner batches to satisfy the requirements across various printers. The inventors have discovered that the use of a non-pigmented or clear toner blended with a pigmented toner can dilute the pigmented toner distribution and have a surprisingly minimal impacting on the overall print density, thereby lowering the cost to manufacture the toner. However, the concentration of the clear toner must be less than 15% by weight of the blended toner composition to achieve the desired print density, preferably less than 8%. Hence, the various printing systems can be suitably tailored regarding the dilution of pigmented toner with a non-pigmented or clear toner to achieve the desired print density, the improvement in toner usage, the lowering toner cost and the toner cost-per page. Another benefit of this approach is to use a single non-pigmented or clear toner with any of the pigmented toners (black, magenta, cyan or yellow) to achieve the required performance in the printer system, and not have to manufacture a new set of black, cyan, magenta or yellow toners at a lower pigment concentration.

As mentioned above, the toners herein include one or more polymer binders. The terms resin and polymer are used interchangeably herein as there is no technical difference between the two. In one embodiment, the polymer binder(s) include styrene-acrylate polymers. In an alternative embodiment, the polymer binder(s) include polyesters. The polyester binder(s) are amorphous and non-crystalline polyester binder. Alternatively, the polyester binder(s) may include a polyester copolymer binder resin. For example, the polyester binder(s) may include a styrene/acrylic-polyester graft copolymer. The polyester binder(s) may be formed using acid monomers such as terephthalic acid, trimellitic anhydride, dodecenyl succinic anhydride and fumaric acid. Further, the polyester binder(s) may be formed using alcohol monomers such as ethoxylated and propoxylated bisphenol A. Example polyester resins include, but are not limited to, T100, TF-104, NE-1582, NE-701, NE-2141, NE-1569, Binder C, FPESL-2, W-85N, TL-17, TPESL-10, TPESL-11 polyester resins from Kao Corporation, Bunka Sumida-ku, Tokyo, Japan, or mixtures thereof. The polymer binder(s) also includes a thermoplastic type polymer such as a styrene and/or substituted styrene polymer, such as a homopolymer (e.g., polystyrene) and/or copolymer (e.g., styrene-butadiene copolymer and/or styrene-acrylic copolymer, a styrene-butyl methacrylate copolymer and/or polymers made from styrene-butyl acrylate and other acrylic monomers such as hydroxy acrylates or hydroxyl methacrylates); polyvinyl acetate, polyalkenes, poly(vinyl chloride), polyurethanes, polyamides, silicones, epoxy resins, or phenolic resins.

Several extra particulate additives (EPAs) have been employed in the surface treatment of toner. These EPAs include various inorganic oxides such as silicon dioxide also known as silica, titanium dioxide also known as titania, aluminum oxide also known as alumina, and composite mixtures of titania, silica and/or alumina. Further metal soaps have also been used to improve the transfer efficiency of a toner.

Inorganic oxides may be obtained using a fuming process or a colloidal process. Fumed silica, also known as pyrogenic silica, is produced in a flame. This type of silica consists of microscopic droplets of amorphous silica fused into branched, chainlike, three-dimensional secondary particles which then agglomerate into tertiary particles. In a typical case, fumed silica is produced by pyrolysis of silicon tetrachloride.

Inorganic oxides such as silica, titania, alumina etc., can vary in their primary particle size from about a 5 nm to several micrometers. Moreover, to achieve uniform print quality across different type of environments, inorganic oxides are surface treated with various treatments such as organosilanes and silicone oil. The extent of surface treatment of the hydroxyl groups in an inorganic oxide can also be varied. In regard to the primary particle size of the silica, the toner flow can be significantly improved by use of smaller primary particle size silica, usually about 5 nm-15 nm in combination with a large primary particle size such as 40 nm-250 nm. This larger sized silica serves as a useful ‘spacer’. Spacers are effective in keeping individual toners apart and hence can improve the storage stability. Silicas with a primary particle size of about 100 nm have been used in CPT toners to be effective spacers. The large silica described as a spacer is typically prepared by a sol-gel or colloidal process. The use of large silica that are smaller than 100 nm, have been shown to be equally effective. For example, an 80 nm silica prepared by a flame or fuming process can also be used. Whereas the medium size silica, about 30 nm-60 nm primary particle size help with toner flow, they are not as effective spacers, and the large silica while functioning as a spacer requires to be used at higher concentrations or levels to help with toner flow. Hence there is a need for a silica that can help both with toner flow and also act as a suitable spacer between surface treated toner particles.

The present disclosure is directed at a toner formulation which comprises a blend of pigmented toner and a non-pigmented or clear toner, wherein the non-pigmented or clear toner is present in about 1% to about 15% by weight of the blended toner composition. The toner particles may be prepared by a melt extrusion process or a chemical process, such as suspension polymerization or emulsion agglomeration. In one example, the toner particles may be prepared via an emulsion agglomeration procedure, which generally provides resin, colorant and other additives. More specifically, the toner particles may be prepared via the steps of initially preparing a polymer latex from a set of polyester resins that are in a polymer resin emulsion form. The polymer latex so formed may be prepared at a desired molecular weight distribution (MWD=Mw/Mn) and may, for example, contain both relatively low and relatively high molecular weight fractions to thereby provide a relatively bimodal distribution of molecular weights. Pigments may then be milled in water along with a surfactant that has the same ionic charge as that employed for the polymer latex. Release agent (e.g., a wax or mixture of waxes) including olefin type waxes such as polyethylene may also be prepared in the presence of a surfactant that assumes the same ionic charge as the surfactant employed in the polymer latex. Optionally, one may include a charge control agent.

The polymer resin emulsion, pigment dispersion and wax dispersion may then be mixed, and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size.

Such a mixture may then be heated to cause a decrease in viscosity and the gel may collapse and relative loose (larger) aggregates, from about 1-25 μm, may be formed, including all values and ranges therein. For example, the aggregates may have a particle size between 3 μm to about 15 μm, or between about μm to about 10 μm. In addition, the process may be configured such that at least about 80-99% of the particles fall within such size ranges, including all values and increments therein. An alkaline base may then be added to increase the pH and reionize the surfactant or one may add additional anionic surfactants. The temperature may then be raised to bring about coalescence of the particles. Coalescence is referenced to fusion of all components. The toner may then be removed from the solution, washed and dried.

It is also contemplated herein that the toner particles may be prepared by a number of other methods including mechanical methods, where a binder resin is provided, melted and combined with a wax, colorant and other optional additives. The product may then be solidified, ground and screened to provide toner particles of a given size or size range. A melt extrusion or conventional toner is produced through a series of operations that are well known the in the art. Typically, the materials comprising the toner formulation are weighed out in the desired proportions and blended until homogeneous. The blending can be accomplished in a Henschel blender, for example an FM-40. The properly proportioned materials are added to the blender and blended at high speed, for example 1600 rpm for two minutes. The now homogeneous mixture can be discharged from the blender and is ready for the extrusion step. An extrusion process is commonly used to melt mix the toner components and provide a uniform dispersion of the components. A Werner & Pfleiderer ZSK-30 twin-screw extruder may be used for this purpose. For example, the mixture of dry materials is fed to the preheated extruder at a feed rate of about 45 pounds per hour (lbs/hr). From the feed zone of the extruder, the extruder barrel temperature increases in steps from about 130° C. to 190° C. The extruder screws rapidly rotate at 300 revolutions per minute. The blended mixture is melted and thoroughly mixed as it passes through the extruder. The hot mixture exits the extruder and is rapidly cooled between two chilled metal rollers. After crushing the cooled mixture, it is necessary to reduce the size of the toner. This may be accomplished with a fluidized bed jet mill such as a Hosokawa Alpine AFG-100. The crushed toner is fed to the jet mill at rate of approximately 1000 grams per hour. As the toner is agitated in the fluidization zone of the jet mill, the smaller particles pass through the rapidly spinning classifier and separated from the air stream by a cyclone. The jet milled material typically contains an excessive number of fine particles (fines), those measuring less than 5 μm. To prevent adverse performance impacts, a large proportion of the fine particles must be removed. As an example, this may be accomplished with an Elbow-jet Air Classifier from Matsubo Corporation. For purposes of this example, it is desirable to remove fines until the number by volume is less than 5%.

The resulting toner may have an average particle size in the range of 3 μm to 25 μm. The toner may then be treated with a blend of extra particulate agents, including hydrophobic fumed alumina, small silica sized less than 20 nm, medium silica sized 30 nm to 60 nm, large fumed silica sized 60 nm to 80 nm, and titania. Treatment using the extra particulate agents may occur in one or more steps, wherein the given agents may be added in one or more steps.

Referring again to the extra-particulate agents that may be used herein, small silica may be understood as silica (SiO₂) having an average primary particle size in the range of 2 nm to 20 nm, or between 5 nm to 15 nm (largest cross-sectional linear dimension) prior to any after treatment, including all values and increments therein. The small silica may be present in the toner formulation as an extra particulate agent in the range of 0.01% to 2.0% by weight of the toner composition, such as 0.1% to 1.0% by weight, including all values and increments therein. In addition, this small silica may be treated with hexamethyldisilazane. An exemplary silica may be available from Evonik Corporation under the tradename AEROSIL and product numbers R812.

Medium sized fumed silica may be understood as silica having a primary particle size in the range of 30 nm to 60 nm, or between 40 nm to 50 nm, prior to any after treatment, including all values and increments therein. Primary particle size may be understood as the largest linear dimension through a particle volume. The medium sized silica may be present in the toner formulation as an extra particulate agent in the range of 0.1% to 3.0% by weight of the toner composition, including all values and increments in the range of 0.1% to 3.0% by weight. The medium sized silicas may also be treated with surface additives that may impart different hydrophobic characteristics or different charges to the silica. For example, the silica may be treated with hexamethyldisilazane (silane), polydimethylsiloxane (silicone oil), etc. Exemplary silicas may be available from Evonik Corporation under the tradename AEROSIL and product numbers RX-50 or RY-50.

Large fumed silica may be understood as silica having a primary particle size in the range of 60 nm to 80 nm, or preferably between 70 nm to 80 nm, prior to any after treatment, including all values and increments therein. The large fumed silica may be present in the toner formulation as an extra particulate agent in the range of 0.1% to 2% by weight, for example in the range of 0.25% to 1.5% by weight of the toner composition. The large fumed silica may also be treated with surface additives that may impart different hydrophobic characteristics or different charges to the silica. For example, the large fumed silica may be treated with hexamethyldisilazane, polydimethylsiloxane, dimethyldichlorosilane, and combinations thereof, wherein the treatment may be present in the range of 1% to 10% by weight of the silica. The weight % of a polydimethylsiloxane on the silica is about 0.5% to about 5% by weight, and more preferably from about 0.5% to about 4%, by weight. Exemplary fumed silicas may be available from Evonik Corporation under the trade name VPRY40S or VPRX40S.

In addition, titania (titanium-oxygen compounds such as titanium dioxide) may be added to the toner composition as an extra particulate additive. The titania may be a combination of an electro-conductive titania with a primary particle size of about 40 nm, and an acicular titania mean particle length in the range of 0.1 μm to 3.0 μm, such as 0.5 μm-2.0 μm and a mean particle diameter in the range of 0.01 μm to 0.2 μm, such as 0.13 μm. The titania may be present in the formulation in the range of about 0.01% to 2.0% by weight by weight of the toner formulation, and preferably such as 0.1% to 1.5%. The acicular titania may include a surface treatment, such as aluminum oxide. An example of acicular titania contemplated herein may include FTL-110 available from ISK USA. An example of an electro-conductive titania contemplated herein may include ET-300W available from ISK USA. Other contemplated titanias may include those available from DuPont; Kemira of Finland under the product designation Kemira RODI or RDI-S; or Huntsman Pigments of Texas under the product name TIOXIDE R-XL.

The disclosed method to make the toner of the present invention operates to provide a finishing to toner particles, as more specifically described below. Such finishing may rely upon what may be described as a device for mixing, cooling and/or heating the particles which is available from Hosokawa Micron BV and is sold under the trade name “CYCLOMIX.” Such device may be understood as a conical device having a cover part and a vertical axis which device narrows in a downward direction. The device may include a rotor attached to a mixing paddle that may also be conical in shape and may include a series of spaced, increasingly wider blades extending to the inside surface of the cone that may serve to agitate the contents as they are rotated. Shear may be generated at the region between the edge of the blades and the device wall. Centrifugal forces may therefore urge product towards the device wall and the shape of the device may then urge an upward movement of product. The cover part may then urge the products toward the center and then downward, thereby providing a feature of recirculation.

The device as a mechanically sealed device may operate without an active air stream and may therefore define a closed system. Such closed system may therefore provide relatively vigorous mixing and the device may also be configured with a heating/cooling jacket, which allows for the contents to be heated in a controlled manner, and in particular, temperature control at that location between the edge of the blades and the device wall. The device may also include an internal temperature probe so that the actual temperature of the contents can be monitored.

For example, conventional toner or chemically prepared toner (CPT) may be combined with one or more extra particulate additives and placed in the above referenced conical mixing vessel. The temperature of the vessel may then be controlled such that the toner polymer resins are not exposed to a corresponding glass transition temperature or Tg which could lead to some undesirable adhesion between the polymer resins prior to mixing and/or coating with the EPA material. Accordingly, the heating/cooling jacket may be set to a temperature of less than or equal to the Tg of the polymer resins in the toner, and preferably to a cooling temperature of less than or equal to about 25° C.

The conical mixing device with such temperature control may then be operated wherein the rotor of the mixing device may preferably be configured to mix in a multiple stage sequence, wherein each stage may be defined by a selected rotor rpm value (RPM) and time (T). Such multiple stage sequence may be particularly useful in the event that one may desire to provide some initial break-up of toner agglomerates. In addition, such initial first stage of mixing may be controlled in time, such that the conical mixer operates at such rpm values for a period of less than or equal to about 60 seconds, including all values and increments therein. Then, in a second stage of mixing, the rpm value may be set higher than the rpm value of the first stage, e.g., at an rpm value greater than about 500 rpm. Furthermore, the time for mixing in the second stage may be greater than about 60 seconds, and more preferably, about 60-180 seconds, including all values and increments therein. For example, the second stage may therefore include mixing at a value of about 1300-1350 rpm for a period of about 90 seconds. Following the above mentioned blending the toner with surface additives can be subjected to a screening step or a classifying step to remove any undesired large agglomerates or particles. It may be appreciated that following the screening or classifying step the toner can be placed in the conical mixer and further blended to achieve better adhesion of the surface additives to the toner surface.

It can therefore be appreciated that with respect to the mixing that may take place in the present invention, as applied to mixing EPA with toner, such mixing may efficiently take place in multiple stages in a conical mixing device, wherein EPA may be added in a first stage wherein the breaking of aggregates may be accomplished, followed by screening, and then additional EPA added before the toner is cooled. In addition, the temperature of the mixing process may again be controlled within such multiple staged mixing protocol such that the heating/cooling jacket and/or the polymer within the toner (as measured by an internal temperature probe) is maintained below its glass transition temperature (Tg). It has been found that the mixing of toner particle with extra particulate additive in the conical mixing device according to the above provides a relatively more uniform surface distribution of EPA.

The extra particulate additives may serve a variety of functions, such as to modify or moderate toner charge, increase toner abrasive properties, influence the ability/tendency of the toner to deposit on surfaces, improve toner cohesion, or eliminate moisture-induced tribo-excursions. The extra particulate additives may therefore be understood to be a solid particle of any particular shape. Such particles may be of micron or submicron size and may have a relatively high surface area. The extra particulate additives may be organic or inorganic in nature. For example, the additives may include a mixture of two inorganic materials of different particle size, such as a mixture of differently sized fumed silica. The relatively small sized particles may provide a cohesive ability, e.g. ability to improve powder flow of the toner. The relatively larger sized particles may provide the ability to reduce relatively high shear contact events during the image forming process, such as undesirable toner deposition (filming).

### Polymer Binder

As mentioned above, the toners herein include one or more polymer binders. The terms resin and polymer are used interchangeably herein as there is no technical difference between the two. In one embodiment, the polymer binder(s) include styrene-acrylate polymers. In an alternative embodiment, the polymer binder(s) include polyesters. The polyester binder(s) are amorphous and non-crystalline polyester binder. Alternatively, the polyester binder(s) may include a polyester copolymer binder resin. For example, the polyester binder(s) may include a styrene/acrylic-polyester graft copolymer. The polyester binder(s) may be formed using acid monomers such as terephthalic acid, trimellitic anhydride, dodecenyl succinic anhydride and fumaric acid. Further, the polyester binder(s) may be formed using alcohol monomers such as ethoxylated and propoxylated bisphenol A. Example polyester resins include, but are not limited to, T100, TF-104, NE-1582, NE-701, NE-2141, NE-1569, Binder C, FPESL-2, W-85N, TL-17, TPESL-10, TPESL-11 polyester resins from Kao Corporation, Bunka Sumida-ku, Tokyo, Japan, or mixtures thereof. The polymer binder(s) also includes a thermoplastic type polymer such as a styrene and/or substituted styrene polymer, such as a homopolymer (e.g., polystyrene) and/or copolymer (e.g., styrene-butadiene copolymer and/or styrene-acrylic copolymer, a styrene-butyl methacrylate copolymer and/or polymers made from styrene-butyl acrylate and other acrylic monomers such as hydroxy acrylates or hydroxyl methacrylates); polyvinyl acetate, polyalkenes, poly(vinyl chloride), polyurethanes, polyamides, silicones, epoxy resins, or phenolic resins.

### Borax Coupling Agent

The coupling agent used herein is borax (also known as sodium borate, sodium tetraborate, or disodium tetraborate). As used herein the term coupling agent refers to a chemical compound having the cross-linking ability to bond two or more components together. Typically, coupling agents have multivalent bonding ability. Borax differs from commonly used permanent coupling agents, such as multivalent metal ions (e.g., aluminum and zinc), in that its bonding is reversible. In the electrophotographic process, toner is preferred to have a low fusing temperature to save energy and a low melt viscosity (“soft”) to permit high speed printing at low fusing temperatures. However, in order to maintain the stability of the toner during shipping and storage and to prevent filming of the printer components, toner is preferred to be “harder” at temperatures below the fusing temperature. Borax provides cross-linking through hydrogen bonding between its hydroxy groups and the functional groups of the molecules it is bonded to. The hydrogen bonding is sensitive to temperature and pressure and is not a stable and permanent bond. For example, when the temperature is increased to a certain degree or stress is applied to the polymer, the bond will partially or completely break causing the polymer to “flow” or tear off The reversibility of the bonds formed by the borax coupling agent is particularly useful in toner because it permits a “soft” toner at the fusing temperature but a “hard” toner at the storage temperature.

It has also been observed that borax surprisingly causes fine particles to collect on larger particles. As a result, borax is particularly suitable as a coupling agent between the core and shell layers of the toner because it collects the components of the toner core to the core particle before the shell is added thereby reducing the residual fine particles in the toner. This, in turn, reduces the amount of acid needed in the agglomeration stage and narrows the particle size distribution of the toner.

Borax also serves as a good buffer in the toner formation reaction as a result of the equilibrium formed by its boric acid and conjugate base. The presence of borax makes the reaction more resistant to pH changes and broadens the pH adjusting window of the reaction in comparison with a conventional emulsion aggregation process. The pH adjusting window is crucial in the industrial scale up of the process to control the particle size. With a broader window, the process is easier to control at an industrial scale.

The quantity of the borax coupling agent used herein can be varied. The borax coupling agent may be provided at between about 0.1% and about 5.0% by weight of the total polymer binder in the toner including all values and increments therebetween, such as between about 0.1% and about 1.0% or between about 0.1% and about 0.5%. If too much coupling agent is used, its bonding may not be completely broken at high temperature fusing. On the other hand, if too little coupling agent is used, it may fail to provide the desired bonding and buffering effects.

### Colorant

Colorants are compositions that impart color or other visual effects to the toner and may include carbon black, dyes (which may be soluble in a given medium and capable of precipitation), pigments (which may be insoluble in a given medium) or a combination of the two. A colorant dispersion may be prepared by mixing the pigment in water with a dispersant. Alternatively, a self-dispersing magenta colorant may be used thereby permitting omission of the dispersant. The magenta colorant may be present in the dispersion at a level of about 5% to about 20% by weight including all values and increments therebetween. For example, the magenta colorant may be present in the dispersion at a level of about 10% to about 15% by weight. The dispersion of the magenta colorant may contain particles at a size of about 50 nanometers (nm) to about 500 nm including all values and increments therebetween. Further, the magenta colorant dispersion may have a pigment weight percent divided by dispersant weight percent (P/D ratio) of about 1:1 to about 8:1 including all values and increments therebetween, such as about 2:1 to about 5:1. The magenta colorant may be present at less than or equal to about 15% by weight of the final magenta toner formulation including all values and increments therebetween. An exemplary magenta pigment PR 293 is available from Clariant Corporation.

### Release Agent

The release agent may include any compound that facilitates the release of toner from a component in an electrophotographic printer (e.g., release from a roller surface). For example, the release agent may include polyolefin wax, ester wax, polyester wax, polyethylene wax, metal salts of fatty acids, fatty acid esters, partially saponified fatty acid esters, higher fatty acid esters, higher alcohols, paraffin wax, carnauba wax, amide waxes and polyhydric alcohol esters.

The release agent may therefore include a low molecular weight hydrocarbon-based polymer (e.g., Mn≤10,000) having a melting point of less than about 140° C. including all values and increments between about 50° C. and about 140° C. For example, the release agent may have a melting point of about 60° C. to about 135° C., or from about 65° C. to about 100° C., etc. The release agent may be present in the dispersion at an amount of about 5% to about 35% by weight including all values and increments therebetween. For example, the release agent may be present in the dispersion at an amount of about 10% to about 18% by weight. The dispersion of release agent may also contain particles at a size of about 50 nm to about 1 μm including all values and increments therebetween. In addition, the release agent dispersion may be further characterized as having a release agent weight percent divided by dispersant weight percent (RA/D ratio) of about 1:1 to about 30:1. For example, the RA/D ratio may be about 3:1 to about 8:1. The release agent may be provided in the range of about 2% to about 20% by weight of the final toner formulation including all values and increments therebetween.

### Surfactant/Dispersant

A surfactant, a polymeric dispersant or a combination thereof may be used. The polymeric dispersant may generally include three components, namely, a hydrophilic component, a hydrophobic component and a protective colloid component. Reference to hydrophobic refers to a relatively non-polar type chemical structure that tends to self-associate in the presence of water. The hydrophobic component of the polymeric dispersant may include electron-rich functional groups or long chain hydrocarbons. Such functional groups are known to exhibit strong interaction and/or adsorption properties with respect to particle surfaces such as the colorant and the polyester binder resin of the polyester resin emulsion. Hydrophilic functionality refers to relatively polar functionality (e.g., an anionic group) which may then tend to associate with water molecules. The protective colloid component includes a water-soluble group with no ionic function. The protective colloid component of the polymeric dispersant provides extra stability in addition to the hydrophilic component in an aqueous system. Use of the protective colloid component substantially reduces the amount of the ionic monomer segment or the hydrophilic component in the polymeric dispersant. Further, the protective colloid component stabilizes the polymeric dispersant in lower acidic media. The protective colloid component generally includes polyethylene glycol (PEG) groups. The dispersant employed herein may include the dispersants disclosed in U.S. Pat. Nos. 6,991,884 and 5,714,538, which are incorporated by reference herein in their entirety.

The surfactant, as used herein, may be a conventional surfactant known in the art for dispersing non-self-dispersing colorants and release agents employed for preparing toner formulations for electrophotography. Commercial surfactants such as the AKYPO series of carboxylic acids available from Kao Corporation, Bunka Sumida-ku, Tokyo, Japan may be used. For example, alkyl ether carboxylates and alkyl ether sulfates, preferably lauryl ether carboxylates and lauryl ether sulfates, respectively, may be used. One particular suitable anionic surfactant is AKYPO RLM-100 available from Kao Corporation, Bunka Sumida-ku, Tokyo, Japan, which is laureth-11 carboxylic acid thereby providing anionic carboxylate functionality. Other anionic surfactants contemplated herein include alkyl phosphates, alkyl sulfonates and alkyl benzene sulfonates. Sulfonic acid containing polymers or surfactants may also be employed.

### Optional Additives

The toner formulation of the present disclosure may also include one or more conventional charge control agents, which may optionally be used for preparing the toner formulation. A charge control agent may be understood as a compound that assists in the production and stability of a tribocharge in the toner. The charge control agent(s) also help in preventing deterioration of charge properties of the toner formulation. The charge control agent(s) may be prepared in the form of a dispersion in a manner similar to that of the colorant and release agent dispersions discussed above.

The following examples are provided to further illustrate the teachings of the present disclosure, not to limit the scope of the present disclosure.

### EXAMPLES

### Example Polyester Resin Emulsion A

A mixed polyester resin having a peak molecular weight of about 9,000, a glass transition temperature (Tg) of about 53° C. to about 58° C., a melt temperature (Tm) of about 110° C., and an acid value of about 7 to about 12 was used. The glass transition temperature is measured by differential scanning calorimetry (DSC), wherein, in this case, the onset of the shift in baseline (heat capacity) thereby indicates that the Tg may occur at about 53° C. to about 58° C. at a heating rate of about 5° C. per minute. The acid value may be due to the presence of one or more free carboxylic acid functionalities (—COOH) in the polyester. Acid value refers to the mass of potassium hydroxide (KOH) in milligrams that is required to neutralize one gram of the polyester. The acid value is therefore a measure of the amount of carboxylic acid groups in the polyester.

150 g of the mixed polyester resin was dissolved in 450 g of methyl ethyl ketone (MEK) in a round bottom flask with stirring. The dissolved resin was then poured into a beaker. The beaker was placed in an ice bath directly under a homogenizer. The homogenizer was turned on at high shear and 10 g of 10% potassium hydroxide (KOH) solution and 500 g of de-ionized water were immediately added to the beaker. The homogenizer was run at high shear for about 2-4 minutes then the homogenized resin solution was placed in a vacuum distillation reactor. The reactor temperature was maintained at about 43° C. and the pressure was maintained between about 22 inHg and about 23 inHg. About 500 mL of additional de-ionized water was added to the reactor and the temperature was gradually increased to about 70° C. to ensure that substantially all of the MEK was distilled out. The heat to the reactor was then turned off and the mixture was stirred until it reached room temperature. Once the reactor reached room temperature, the vacuum was turned off and the resin solution was removed and placed in storage bottles.

Example Polyester Resin Emulsion B

A polyester resin having a peak molecular weight of about 6500, a glass transition temperature of about 49° C. to about 54° C., a melt temperature of about 95° C., and an acid value of about 18 to about 27 was used to form an emulsion using the procedure described in Example Polyester Resin A, except using 12.8 g of the 10% potassium hydroxide (KOH) solution. The particle size of the Polyester Resin Emulsion B was between. about 160 nm and about 220 nm (volume average) as measured by a NANOTRAC Particle Size Analyzer. The pH of the resin solution was between about 6.3 and about 6.8.

### Example Polyester Resin Emulsion C

A polyester resin having a peak molecular weight of about 13,000, a glass transition temperature of about 58° C. to about 62° C., a melt temperature of about 117° C., and an acid value of about 17 to about 23 was used to form an emulsion using the procedure described in Example Polyester Resin A, except using 10 g of the 10% potassium hydroxide (KOH) solution. The particle size of the Polyester Resin Emulsion C was between about 190 nm and about 240 nm (volume average) as measured by a NANOTRAC Particle Size Analyzer. The pH of the resin solution was between. about 6.5 and about 7.0.

### Example Wax Emulsion

About 12 g of AKYPO RLM-100 polyoxyethylene(10) lauryl ether carboxylic acid from Kao Corporation, Bunka Sumida-ku, Tokyo, Japan was combined with about 325 g of de-ionized water and the pH was adjusted to 7-9 using sodium hydroxide. The mixture was then processed through a microfluidizer and heated to about 90° C. About 60 g of polyethylene wax from Petrolite, Corp., Westlake, Ohio, USA was slowly added while the temperature was maintained at about 90° C. for about 15 minutes. The emulsion was then removed from the microfluidizer when the particle size was below about 300 nm. The solution was then stirred at room temperature. The wax emulsion was set to contain about 10% to about 18% solids by weight.

### Example Cyan Pigment Dispersions

About 15 g of AKYPO RLM-100 polyoxyethylene(10) lauryl ether carboxylic acid from Kao Corporation, Bunka Sumida-ku, Tokyo, Japan was combined with about 300 g of de-ionized water and the pH was adjusted to ˜7-9 using sodium hydroxide. About 15 g of Solsperse 27000 from Lubrizol Advanced Materials, Cleveland, Ohio, USA was added and the dispersant and water mixture was blended with an electrical stirrer followed by the relatively slow addition of 150 g of Pigment Blue 15:3. Once the pigment was completely wetted and dispersed, the mixture was added to a horizontal media mill to reduce the particle size. The solution was processed in the media mill until the particle size was about 200 nm. The final pigment dispersion was set to contain about 30% to about 35% solids by weight.

### Toner Formulation Examples

### Preparation of CPT Clear Toner

In a 5 L reactor was placed about 11.25 parts of a paraffin wax dispersion, 42.24 parts of a medium Tg (Tg=56° C.) polyester resin emulsion A, 16.18 parts of a low Tg (Tg=53° C.) polyester resin emulsion B and sufficient water to achieve about 13% solids. De-stabilization of the pigment dispersion, wax dispersion, and latex emulsions were achieved by the addition of an acid such as sulfuric acid, until a pH of about 1.5 to 2.3 is achieved. The destabilization can involve a change in stirring speed to achieve a desired particle size. The temperature was then increased to about 41° C. and held at this temperature for about 45 minutes to about 90 minutes, to achieve a particle size of about 5.0-5.2 μm (volume). Upon reaching the desired particle size, about 2.77 parts of borax dispersion is added followed by stirring for about 5 to 15 minutes. About 31.41 parts of a high Tg (Tg=60° C.) polyester resin emulsion C is then added, along with de-ionized water. The reaction mixture is then heated to about 45° C. and stirred until a particle size of about 6.0-6.3 μ.m is achieved. An aqueous base, such as aqueous sodium hydroxide (5% solution), is then added increase the pH to about 6.75-6.9. The temperature is then increased to about 83° C. and the toner shape is monitored by measuring circularity in a FPIA3000 Sysmex instrument. The particle size is also monitored. On achieving a circularity of about 0.984, the toner slurry is cooled. The cooling process involves the addition of the hot toner slurry to an external reactor containing an equivalent amount of water at a temperature of about 20° C. The toner particles are then filtered out of the toner slurry, washed with de-ionized water, and filtered again. This process is repeated until the conductivity of the filtrate is less than or equal to about 50/cm. The toner particles are then dried. The resulting toner had a volume average particle size of 6.07 μm, and a number average particle size of 5.37 μm. Fines (<2 μm) were present at 1.76% (by number) and the toner possessed a circularity of 0.984.

### Preparation of CPT Pigmented Toner

The Example Polyester Resin Emulsions A and B and the Example Polyester Resin Emulsion C are used in a core to shell ratio of 65:35 (wt.). Components were added to a 50-liter reactor in the following relative proportions: 8470 g (29.75%) of the Example Polyester Resin Emulsion A, 3240 g of Polyester resin Emulsion B (29.75%), 1260 g (30.5%) of the Cyan Pigment Dispersion, 21300 g (35.0%) of the Example Wax Emulsion. Deionized water was then added so that the mixture contained about 12% to about 15% solids by weight.

The mixture was heated in the reactor to 25° C. and a circulation loop was started consisting of a high shear mixer and an acid addition pump. The mixture was sent through the loop and the high shear mixer was set at 16,000 rpm. Acid was slowly added to the high shear mixer to evenly disperse the acid in the toner mixture so that there were no pockets of low pH. Acid addition took about 6 minutes with 1810 g of 2% sulfuric acid solution. The flow of the loop was then reversed to return the toner mixture to the reactor and the temperature of the reactor was increased to about 35-40° C. Once the particle size reached 5.0 μm to 5.2 μm (volume average), 5% (wt.) borax solution 610 g of solution, 4.1% solution) was added. After the addition of borax, 6310 g (29.75%) of the Example Polyester Resin Emulsion C was added to form the shell. The mixture was stirred for about 5 minutes and the pH was monitored. Once the particle size reached 6.28 μm (volume average), 4% NaOH was added to raise the pH to about 6.8 to stop the particle growth. The reaction temperature was held for one hour. The temperature was increased to 82° C. to cause the particles to coalesce. This temperature was maintained until the particles reached their desired circularity. The final toner had a volume average particle size of 6.07 μm, and a number average particle size of 5.47 μm. Fines (<2 μm) were present at 0.47% (by number) and the toner possessed a circularity of 0.972.

The Control CPT Pigmented Toner and the CPT Clear Toner were characterized for their particle average particle diameter, average particle size and average circularity. These results are shown in Table 1. Table 2 shows the thermal properties for the Control CPT Pigmented Toner and the CPT Clear Toner. As seen in Tables 1 and 2, particle size for the Control CPT Pigmented Toner and the CPT Clear Toner were similar, with relatively small differences in their circularity. Similarly, thermal properties such as glass transition temperature, crystalline melt for the wax and the wax incorporation as indicated by crystalline enthalpy of fusion as shown as ΔHf were similar for the Control CPT Pigmented Toner and the CPT Clear Toner.

TABLE 1
Characterization of toners for particle size and shape:
Number average and volume average particle size is
calculated between 2 μm and 15 μm. % Fines is
based on a number distribution, between 0.6 μm-2 μm

| | | Avg. | Avg | | |
|---|---|---|---|---|---|
| | | Particle | Particle | | % Fines |
| | Pigment | Diameter | Diameter | Avg | (number, |
| Toner ID | level/Type | (Num.) | (Vol) | Circularity | 0.6-2 μm) |
| Control CPT | 5% | 5.47 | 6.07 | 0.972 | 0.47 |
| Pigmented | (PB15:3) | | | | |
| Toner | | | | | |
| CPT Clear | 0% | 5.37 | 6.09 | 0.984 | 1.76 |
| Toner | (None) | | | | |

TABLE 2
Thermal properties for the Control CPT
Pigmented Toner and the CPT Clear Toner

| | | | Crystalline | |
|---|---|---|---|---|
| | | Tg Onset | melt | Enthalpy |
| | Pigment | (1^{st} scan/ | (1^{st} scan/ | of fusion |
| Toner ID | level/Type | 2^{nd} scan) | 2^{nd} scan) | (J/g) |
| Control CPT | 5%/PB15:3 | 64° C./52° C. | 74° C./74° C. | 21.6 |
| Pigmented | | | | |
| Toner | | | | |
| CPT Clear | 0%/None | 65° C./53° C. | 74° C./74° C. | 22.8 |
| Toner | | | | |

The Control CPT Pigmented Toner and the inventive CPT Blended Toner (ratio of the CPT Pigmented Toner to the Clear Toner was 85% to 15%) were evaluated for print performance in a Lexmark CS725 printer. These two toners were surface treated with a set a of small sized silica (R812), medium sized silica (RY-50), small electroconductive titanium dioxide, and large size titanium dioxide such as FTL-110, and a large sized fumed silica (VPRY40S) in a CYCLOMIX blender. Following the surface treatment, Control CPT Pigmented Toner and the CPT Blended Toner were placed in a Lexmark CS 725 and evaluated for print performance, using a 2.5% print coverage, at a 50 page-per-minute print speed, in a lab environment. Results from this test are shown below in Table 3.

TABLE 3
Print metrics following the evaluation in a Lexmark CS725 printer.

| | Cyan toner/ | Toner Q/M | DR M/A | | Toner | |
|---|---|---|---|---|---|---|
| | Clear toner | (μC/g) | (mg/cm²) | L* | usage | |
| Toner ID | blends (%) | (0K/4K) | (0K/4K) | (0K/4K) | (mg/pg) | Starve |
| CPT | 100%/0% | −80.0/−57.0 | 0.34/0.35 | 63.5/53.8 | 9.1 | Yes |
| Pigmented | | | | | | |
| Toner | | | | | | |
| CPT Blended | 85/15% | −78.0/−51.3 | 0.32/0.36 | 68.9/59.0 | 7.4 | No |
| Toner | | | | | | |

Visual qualitative analysis of the initial prints obtained by printing the test toner does not show the areas of large white voids in the Clear CPT Toner, which may correspond to either agglomerates of the Clear toner or selective development of the clear toner. As can be seen from Table 3, there is a slight change in the print density (L*) of the CPT Blended Toner compared to the print density of the CPT Pigmented Toner. This corresponds to the presence of the clear toner in the CPT Blended Toner, thereby indicating co-development of the clear toner along with the pigmented cyan toner. In Table 3, print density is measured using a Gretagmacbeth spectrophotometer, and illustrated by the term L*. The toner charge for the CPT Blended Toner and the CPT Pigmented Toner are similar, as is the toner mass on the developer roller. The toner usage tends to decrease as the amount of clear toner is added to the blended toner. As the clear toner is developing along with the pigmented toner, and increases the L*, or lowers the print density, lowering in toner usage is not a result of a light print. It was also found the CPT Pigmented Toner exhibited a tendency towards starvation, however, the CPT Blended Toner did not exhibit the starvation. Starvation may be described as severe non-uniformity on the printed page, possibly a consequence of the developer roller not able to supply a uniform mass of toner to the organic photoconductor drum. The thus described non-uniformity could be a result of the toner having a very high charge at the developer roller/doctor blade nip and not being transferred to the photoconductor drum (high adhesion to surface), and poor replenishment of developer roller for the subsequent revolutions down the page. The fact that the CPT Blended Toner does not show this defect, may be indicative of more uniform charging behavior and delivery on to the photoconductor imaging surface.

The use of 15% of non-pigmented or clear toner as a blend in CPT Blended Toner in Table 3 impacted the print density by about 4-5 L* units. Using the same cyan CPT toner, a blend was prepared with a clear toner at a 100%/0% and 90%/10%, ratio, by weight respectively. In this instance, the toner blends were surface treated with a mixture of small silica, medium silica, a large silica and iron oxide. The toner was printed using a Lexmark CS725 printer, the print density as measured with a GretagMacBeth spectrophotometer was about 55 and 57, respectively. The print density is expected to be lowered due to the development of the non-pigmented or clear toner along with the pigmented toner, it appears at the lower blend ratios, such as 10%, the print density is not significantly altered.

The role of a clear or unpigmented toner has been shown in a chemical toner system. This was further explored with a toner derived by a mechanical or melt extrusion process. So as to achieve this a black pigmented toner was prepared by a melt extrusion process as outlined below. The melt extrudate was quickly cooled with a chilled roller and coarsely crushed. Following this operation, the crushed toner was reduced in size using an AFG 100 fluidized bed jet mill from Hosokawa Micron Powder Systems. The majority of a conventional or milled toner is comprised of a binder resin or combination of resins such as Styrene Acrylic, polyesters or hybrids thereof. For purposes of this example a mixture of polyester resins is considered, one with a Tg of about 56° C., one with a Tg of about 66° C. and/or one with a Tg of 58° C. In addition to colorants previously described, it is desirable to incorporate a hydrocarbon wax such as polyethylene, polypropylene or copolymers thereof. In this example, about 2 to 3% of a polyethylene wax with a melting point of 99° C. is suitable. It is also a common practice to include a material to help compatibilize the wax in the binder resins. Examples of these materials are esterified waxes, copolymers of styrene and ethylene/propylene, and copolymers of styrene with ethylene/butylene. The amount of compatibilizing agent is highly dependent on the types of binder resin, wax and compatibilizing agent itself with ranges of 0.5 to 3% by weight being typical. It is common to also include a charge control agent such as zinc salicylate typically in the range of 0.5 to 3%. In a typical process, two resins with glass transition temperatures of about 56° C. and 66° C. and a resin with a Tg of about 58° C., a pigment if required such as a carbon Black at about 4 to 8% by weight, along with a release agent having a peak melt temperature of about 99° C., compatibilizing agent and a charge control agent such as a zinc salicylate were mixed. Following this process, the mixture was introduced into a Werner Pfleiderer twin screw extruder at a feed rate of about 45 pounds per hour (lbs/hr) while the screws are rotating at 300 revolutions per minute. The temperature along the extruder was increased from about 130° C. in the coldest zone to about 190° C. at the exit zone. Toner melt extrudate was quickly cooled, crushed and milled to achieve a particle size of 8 μm (volume), a Tg of about 62° C. Toner melt viscosity may be characterized by the determination of T₁ and T₄, temperature points determined with a capillary rheometer. For this example, a model CFT-550D from Shimadzu Corporation of Japan was utilized. The test toner was pressed into a uniform cylindrical pellet approximately 11 mm in diameter and 22 mm in length. The pellet was placed in the instrument fitted with a 1 mm diameter die. A load of 20 kg was applied through a piston as the sample was heated at a rate of 6° C. per minute. The temperatures after 1 mm of die travel (T₁) and 4 mm of travel (T₄) were noted and recorded. The milled black toner exhibited a T1/T4 of 112.5° C./121.7° C., respectively. This resulting toner is referred to as Conventional Black Toner.

A milled or pulverized non-pigmented or clear toner was prepared in a manner similar to the Conventional Black toner, with the exception that no Carbon black was used. The resulting clear conventional toner had a particle size of about 8 μm, a Tg of about 62° C. This clear conventional toner exhibited a T1/T4 of 103.7° C./109.3° C., respectively.

The Conventional Black Toner and the inventive Conventional Black/Clear blended toner system (ratio of the Conventional Black Toner to the Conventional Clear Toner was 95% to 5%) were evaluated for print performance in a Lexmark CS725 printer. In a Cyclomix, toner blends, as shown in Table 4, were blended with 0.5 parts of small silica, such as Aerosil R812, 0.6 parts of titania such as FTL-110, 2 parts of a medium silica Aerosil RY50 and about 0.6 parts of a large silica, such as VPRY40S. The Conventional Black Toner and the inventive Conventional Black Blended Toner were evaluated for print performance in a Lexmark CS725 printer. The Conventional Black Toner and the inventive Conventional Black blended Toner were surface treated with a set a of small sized silica, medium sized silica, small and large size titanium dioxide and a large sized fumed silica in a CYCLOMIX blender. Following this surface treatment, the Conventional Black Toner and the inventive Conventional Black Blended Toner were placed in a Lexmark CS 725 and evaluated for print performance, using a 2.5% print coverage, at a 50 page-per-minute print speed, in a lab environment. Results from this test are shown below in Table 4.

TABLE 4
Print metrics following the evaluation in a Lexmark CS725 printer.

| | Black Toner/ | Toner usage |
|---|---|---|
| Toner ID | Clear toner (%) | (mg/pg) |
| Conventional Black Toner | 100%/0% | 11.4 |
| Conventional Black | 95%/5% | 11.2 |
| Blended Toner | | |

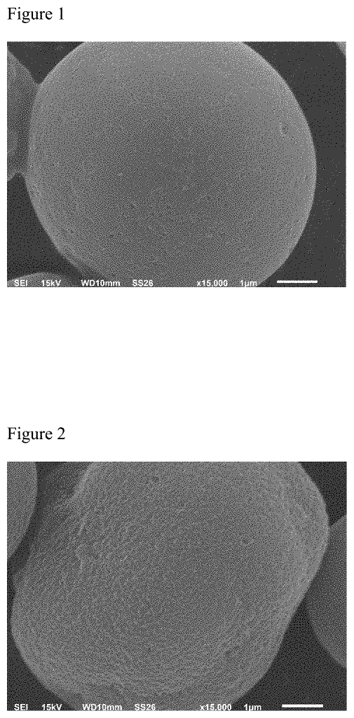

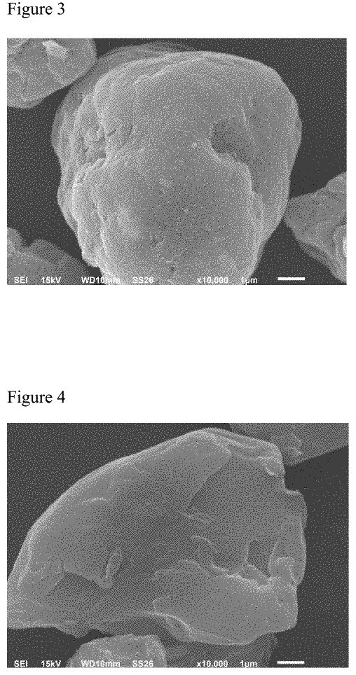

The CPT cyan pigmented toner, CPT Clear toner, Conventional Black Toner and the Conventional Clear Toner were characterized via scanning electron microscopy (SEM). To study the surface of these toners, toners were subjected to oxygen plasma etching for varying times, from about 3 minutes to about 9 minutes and then studied using a SEM instrument. FIGS. 1 and 3 correspond to the CPT cyan toner and the Conventional Black Toner, respectively, and as is seen, the holes or divots observed correspond to areas where crystalline wax were present. Also, the etched surfaces show some white particles, these correspond to the pigment in the toner. Pigment etches or oxidizes at a different rate than the wax and polyester resin. Hence it is possible to differentiate the raw materials that are at or near the surface of the toner particle. For the CPT cyan toner, the wax domains are >200-300 nm, in comparison there are fewer wax domains that may be greater than about 200 nm for the CPT clear toner. As shown in FIG. 2, the CPT clear toner exhibits a more orange-peel like surface in comparison to a smoother surface for the CPT cyan toner. Whereas FIG. 3 shows wax and pigment domains on the surface of the Conventional Black Toner that were >400 nm in size, FIG. 4 shows that the non-pigmented or clear conventional toner has a wax distribution on toner surface that was close to the primary particle size of wax in the wax dispersion, i.e. <200 nm. This result indicates that the pigment domain is relatively small, with little to no agglomeration of pigment on the toner surface. This also indicates that the pigment is relatively well dispersed in the toner bulk and hence not agglomerated on the toner surface. Hence it is apparent that surface of a clear toner comprises of wax particles that may be in their primary particle size and not aggregated.

Rheological properties for the above described CPT cyan toners were studied using a AR-G2 Rheometer, and measuring storage modulus, elastic modulus and complex viscosity at various temperatures at 1 rad/sec and 63 rad/sec, respectively. Results are shown below in Table 5 and for illustration purposes, two temperatures chosen were 120° C. and 200° C. Whereas, the CPT Pigmented Toner (cyan) shows a complex viscosity of about 1100Pa·sec, the clear toner exhibits a complex viscosity of about 400, as measured at about 130° C., the CPT Blended Pigment Toner at a ratio of 90/10 blend of the CPT Blended Pigment Toner to the CPT Clear Toner is about 800. At higher temperatures, (200° C.), the corresponding numbers are 1000, 5 and 105, respectively. Hence the presence of the non-pigmented or clear toner can be used a method to lower the viscosity of the CPT blended toner.

TABLE 5
Rheological properties and fusing performance of toners

| | | | Complex |
|---|---|---|---|
| | G′ (Pa · s) | G″ (Pa · s) | Viscosity (Pa) |
| | (130° C./ | (120° C./ | (130° C./ |
| Toner ID | 200° C.) | 200° C.) | 200° C.) |
| CPT Pigmented | 839/836 | 1695/399 | 1100/1000 |
| Toner | | | |
| CPT Blended | 747/679 | 1567/341 | 800/105 |
| Pigment | | | |
| Toner (90/10) | | | |
| CPT Clear | 670/538 | 1342/262 | 400/5 |
| toner | | | |

Hence it may be appreciated that a method to lower toner cost, while increasing toner usage efficiency and lower cost-per-page for printing may be achieved by the addition of a non-pigmented or clear toner to a pigmented toner system. Resulting toner also exhibits a lower complex viscosity.

1. A blended chemically processed toner composition comprising:
(a) a pigmented chemically prepared toner having a core having an outer surface, the core having components including a first and a second polymer binder, a colorant and a release agent; a borax coupling agent located on the outer surface of the core between the core and the shell; and a shell formed around the outer surface of the core and the borax coupling agent, the shell including a third polymer binder; and
(b) a non-pigmented chemically prepared toner having a core having an outer surface, the core having components including a first and a second polymer binder, and a release agent; a borax coupling agent located on the outer surface of the core between the core and the shell; and a shell formed around the outer surface of the core and the borax coupling agent, the shell including a third polymer binder, wherein the non-pigmented chemically processed toner is about 1% to about 15% by weight of the blended chemically processed toner composition.

2. The blended chemically processed toner composition of claim 1, wherein the non-pigmented chemically processed toner is less than 8% by weight of the blended chemically processed toner composition.

3. The blended chemically processed toner composition of claim 1, further comprising an extra particulate additive package including:
(a) a small sized silica having a primary particle size of about 2 nm to about 20 nm;
(b) a medium sized silica having a primary particle size of about 30 nm-60 nm;
(c) a large silica having a primary particle size of about 60 nm-80 nm;
(d) an acicula titania; and
(e) electroconductive titania dioxide.

4. The blended chemically processed toner composition of claim 1, wherein the first polymer binder, the second polymer binder and the third polymer binder are polyester resins.

5. The blended chemically processed toner composition of claim 1, wherein the blended chemically processed toner composition has a complex viscosity of 800 at 130° C. and 105 at 200° C.
